(19) United States
(12) Patent Application Publication
(10) Pub. No.: US 2007/0147019 A1
(43) Pub. Date: Jun. 28, 2007

(54) Mounting frame for a computer case

(76) Inventor: Yang-Yuan Hsu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/600,048

(22) Filed: Nov. 16, 2006

(30) Foreign Application Priority Data
Dec. 23, 2005 (TW) 94222552

(51) Int. Cl. H02B 1/01

(52) U.S. Cl. 361/829

(57) ABSTRACT

A mounting frame includes a main body, a receiving groove, a plurality of rectangular hole, an engagement groove, a pair of first threaded holes and a pair of second threaded hole. The receiving groove is positioned within the main body, extends to its bottom surface thus a receiving hole is formed. The rectangular holes are separated at an equal distance one another and aligned along a straight line, the rectangular holes are in communication with both the receiving hole and the receiving groove. The engagement groove is positioned within the main body, in vicinity of the front of the metallic main body and extending to the front of the metallic main body thus an opening is formed. Both the pair of first threaded holes and second threaded holes have inner threads positioned on their two ends. The mounting frame is applicable to various computer cases without different dedicated mounting frames.

### BACKGROUND OF THE INVENTION

1. Field of the Invention

The present invention relates to a mounting frame for a computer case, and in particular, to a mounting frame which is applicable within the computer case and is used to mount various components.

2. Description of Related Art

Users usually want different components and equipment to meet their special need when mounting industrial computers. Manufacturers setup your system with various mounting frames and associated accessories when they receive users' order. That is, what's so called “customization”. Conventional computer case (not shown) is equipped with special configuration to meet users' need and includes various mounting frames. Different mounting frames are merely implemented at certain position and used to mount certain components. Above all, different frames are not interchangeable. Because types of the mounting frames are various and it is laborious to assemble the mounting frames, it is easy to make mistakes and needs reassembly. In addition, to manufacture various mounting frames results in higher costs, and it is not easy to do inventory management.

Thus, there is a need for a mounting frame for a computer case.

### SUMMARY OF THE INVENTION

It is an object of the present invention to provide a mounting frame together with accessories and mounting components without various mounting frames to setup a customized computer case.

To achieve object of the present invention, an mounting frame includes a main body which is metallic; a receiving groove positioned within the main body and extending to its bottom so that a receiving hole is formed; a plurality of rectangular hole positioned at the top surface of the main body and corresponding to the receiving groove and separated at an equal distance one another and aligned along a straight line, and the rectangular holes in communication with both the receiving hole and the receiving groove; an engagement groove, positioned within the main body and in vicinity of the front of the main body and extending to the front of the main body so that an opening is formed, and further including a first engagement rail and a second engagement rail which are parallel; a pair of first threaded holes, having an inner thread positioned on their two ends, and a pair of second threaded holes, having an inner thread positioned on their two ends.

### BRIEF DESCRIPTION OF THE DRAWINGS

The present invention can be fully understood from the following detailed description and preferred embodiment with reference to the accompanying drawings, in which:

FIG. 1 is a perspective view of a mounting frame of the present invention;

FIG. 2 is a side view of a mounting frame of the present invention;

FIG. 3 is a perspective view of a mounting frame together with a side plate and a partition plate according to the present invention;

FIG. 4 is a perspective view of a mounting frame together with a guide frame according to the present invention;

FIG. 5 is a perspective view of a mounting frame together with a mounting strip according to the present invention; and

FIG. 6 is a perspective view of a mounting frame together with a mounting strip and a mounting plate according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

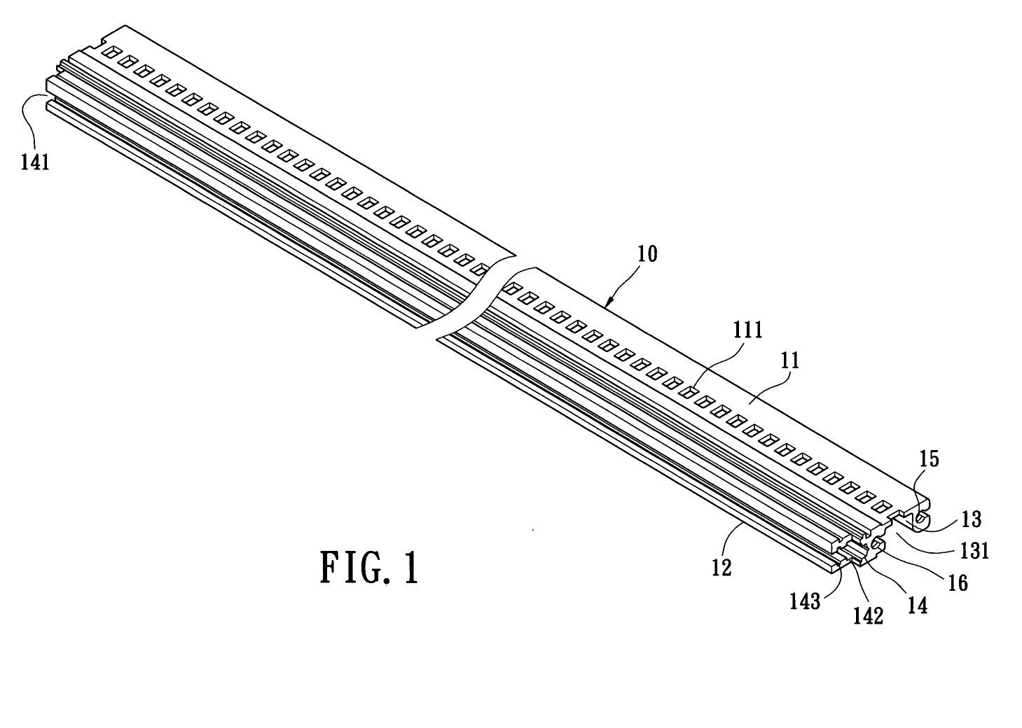

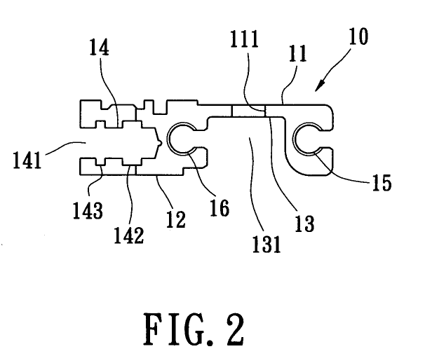

Reference is made to FIGS. 1-2. According to the present invention, a mounting frame includes a main body 10, a receiving groove 13, a plurality of rectangular holes 111, an engagement groove 14, a pair of first threaded holes 15 and a pair of second threaded holes 16.

The main body 10 is metallic and includes a lumpy surface near at its top surface 11 so that aesthetic feeling of the main body 10 is increased and weight of the main body 10 is decreased. In this light, the mounting frame of present invention is light-weighted and has good rigidity.

The receiving groove 13 is positioned within the main body 10 and extends to its bottom surface 12 so that a receiving hole 131 is formed. Other supporting components may be moved into or out of the main body 10 through the receiving hole 131. The receiving groove 13 is used as a receiving space and is used to receive other mounting components.

The rectangular holes 111 are positioned at the top surface 11 of the main body 10 and are separated at an equal distance one another and aligned along a line. The rectangular holes 11 are in communication with both the receiving hole 131 and the receiving groove 13. The rectangular holes 111 together with mounting components may be used to mount components of the computer case because the rectangular holes 111 are separated at an equal distance one another. The components of computer case corresponding to the rectangular holes are mounted. In this light, the computer case is multifunctional. For example, it is easy to increase or decrease the number of interface adapter card slots.

The engagement groove 14 is positioned within and extending to the main body 10 and in vicinity of the front side of the main body 10 so that an opening 141 is formed. In addition, the engagement groove 14 has a first engagement rail 142 and a second engagement rail 143 which are parallel. Both the first engagement rail 142 and the second engagement rail 143 are positioned at the inner surface of the main body 10. Other components are assembled with the first engagement rail 142 and the second engagement rail 143 so that a mounting structure is formed.

The pair of first threaded holes 15 are respectively positioned at two opposite sides of the main body 10 and coaxial and each of them has an inner thread to be engaged with screws. Thus, accessories are positioned near one side of the main body 10.

The pair of second threaded holes 16 are respectively positioned at two opposite sides of the main body 10 and between the engagement groove 14 and pair of first threaded holes 15. In addition, the pair of second threaded holes 16 are coaxial and each of them has an inner thread to be engaged with screws. Thus, accessories are positioned near one side of the main body 10.

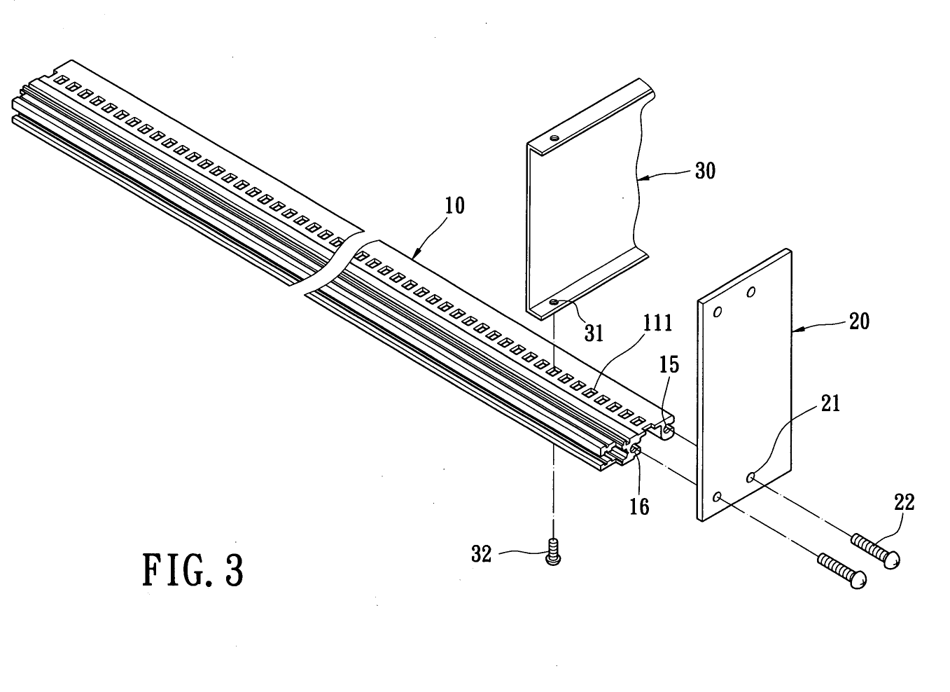

Reference is made to FIG. 3. A side plate 20 of the computer case is mounted at the main body 10 by screws 22 because the screws 22 thread through screw holes 21 of the side plate 20 and engage with the inner threads of the first threaded holes 15 and the second threaded holes 16. Thus, the side plate 20 is mounted at the right side of the main body 10. Similarly, the side plate 20 can be mounted at the left side (not shown) of the main body 10 in the same way. In addition, the main body 10 can be mounted with a partition plate 30 when screws 32 threads through the rectangular holes 111 and a screw hole 31 of the partition plate 30. Thus, the partition plate 30 is mounted at the top surface 11 of the main body 10 so that some partitions within the computer case are formed. Similarly, a dust cover (not shown) of the computer case can be mounted at the top surface 11 of the main body 10.

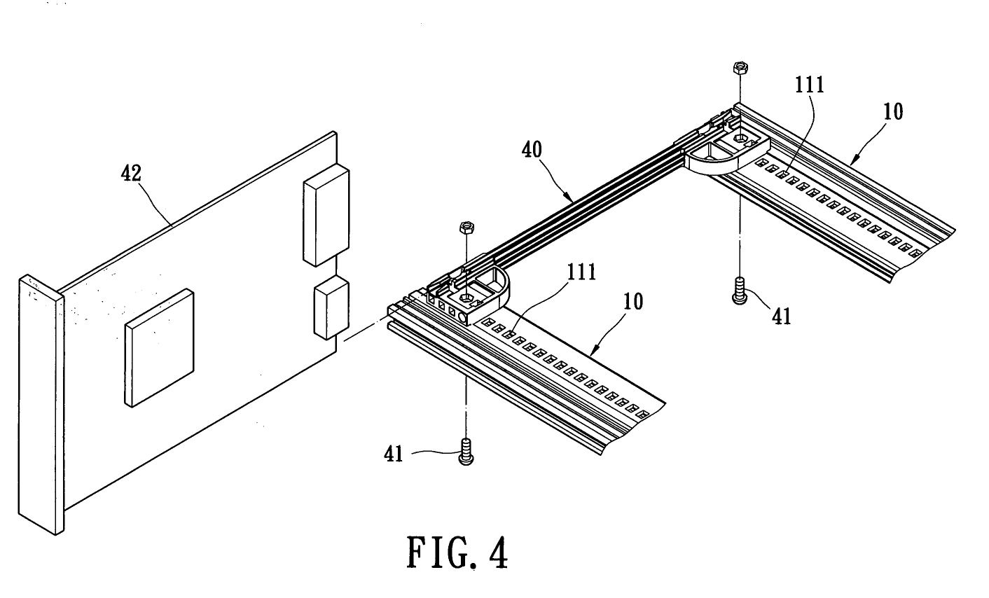

Reference is made to FIG. 4. An interface adapter card 42 is electrically connected with the computer case when two main bodies 10 are assembled with a guide rail 40. A hook mechanism and a mounting mechanism (not shown) of the guide rail 40 correspond with and are inserted into the rectangular holes 111 to prevent the guide rail 40 from getting loose. Thus, the guide rail 40 is positioned at the two main body 10. Screws 41 thread through the receiving hole 131 at the bottom surface of the main body 10 and the rectangular holes 111 so that the guide rail 40 is mounted at the two main body 10 and heads of the screws 41 are received in the receiving groove 13. To the contrary, hook mechanism and mounting mechanism (not shown) of the guide rail 40 and the screws 41 are removed from the receiving hole 131 of the receiving groove 13 so that the guide rail 40 is disassembled with the main body 10. As described above, the guide rail 40 may be separately positioned at the rectangular holes 111 of the main body 10 so that the number of the interface adapter cards inserted is increased or decreased very quickly to meet the users' need.

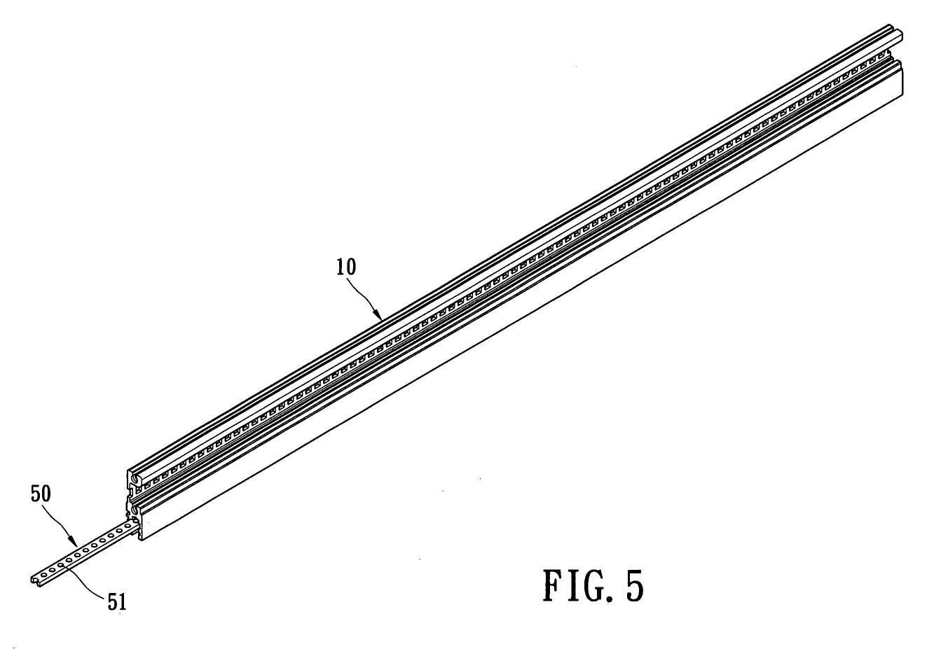

Reference is made to FIG. 5. According to the present invention, a mounting strip 50 having a plurality of screw holes 51 engaged with the first engagement rail 142 positioned at one side of the main body 10. However, the mounting strip 50 may be engaged with the first engagement rail 142 or the second engagement rail 143 to meet the users' need. In addition, two mounting strips 50 (not shown) may be positioned within the main body 10 simultaneously so that computer case has a capability of reducing vibration.

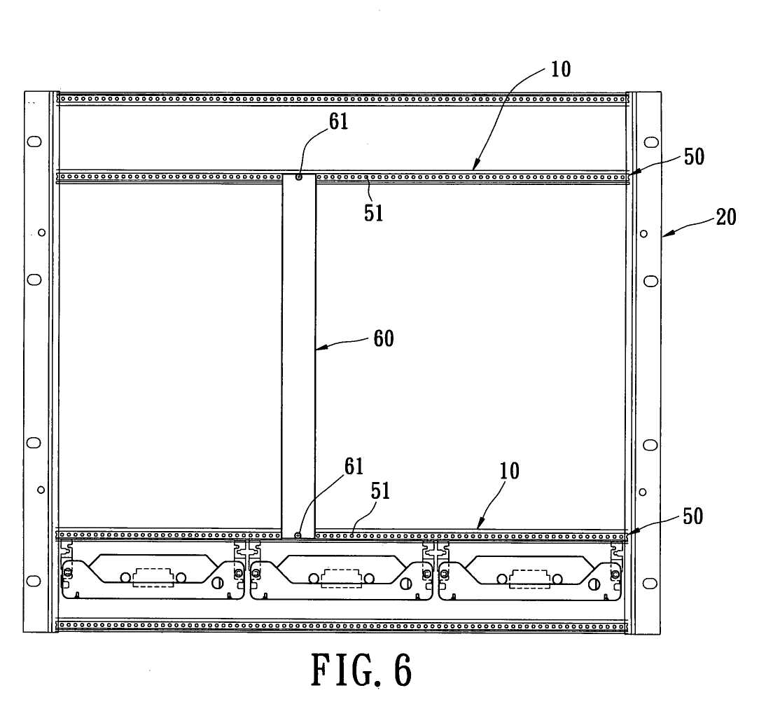

Reference is made to FIG. 6. FIG. 6 illustrates that the mounting strip 50 and the main body 10 are implemented in the computer case. Two main body 10 and two mounting strips 50 are respectively mounted at an upper portion and lower portion of the computer case. The mounting plate 61 is mounted on the computer case when mounting plate screws 61 thread through the opening 141 of the main body 10 and the engagement groove 14 and engaged with the screw holes 51 of the mounting strip 50. A part of the mounting plate screws 61 threading through the mounting strip 50 are received within the engagement groove 14. Two mounting strips 50 may be inserted into the main body 10 so that the mounting plate screws 61 engage with the screw holes 51 of the two mounting strips 50. Thus, capability of reducing vibration is increased and screws do not get loose even through the computer case is subjected to vibration.

As described above, the mounting frame of the present invention is used to mount various components of the computer case. The side plate 20 and the partition plate 30 together with dust cover (not shown) and the guide rail 40 may be mounted on the side and tip surface of the computer case respectively. Thus, it is easy to increase or decrease number of adapter card slots. Because the only one type of mounting frame is utilized, we have no difficulty in assembling and save much more time and labors. Cost is lowered and it is easy to do inventory management.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A mounting frame, comprising:
a main body, made of metal;
a receiving groove, positioned within the main body and extending to its bottom so that a receiving hole is formed;
a plurality of rectangular holes, positioned at the top surface of the main body and corresponding to the receiving groove and separated at an equal distance one another and aligned along a straight line, and the rectangular holes in communication with both the receiving hole and the receiving groove;
an engagement groove, positioned within the main body and in vicinity of the front of the main body and extending to the front of the main body so that an opening is formed, and further including a first engagement rail and a second engagement rail which are parallel;
a pair of first threaded holes, having an inner thread positioned on their two ends; and
a pair of second threaded holes, having an inner thread positioned on their two ends.

2. The mounting frame as claimed in claim 1, wherein the main body includes a lumpy surface near its top surface.

3. The mounting frame as claimed in claim 1, wherein the rectangular holes are separated at an equal distance one another and aligned along a straight line.

4. The mounting frame as claimed in claim 1, wherein the first engagement rail is positioned at the inner surface of the main body.

5. The mounting frame as claimed in claim 1, wherein the second engagement rail is positioned at the inner surface of the main body.

6. The mounting frame as claimed in claim 1, wherein the pair of first threaded holes are coaxial.

7. The mounting frame as claimed in claim 1, wherein the pair of second threaded holes are coaxial.
